(19) United States
(12) Patent Application Publication
(10) Pub. No.: US 2012/0015278 A1
(43) Pub. Date: Jan. 19, 2012

(54) SOLID OXIDE FUEL CELL AND FUEL CELL ASSEMBLY THEREOF

(76) Inventors: Duk-Hyoung Yoon, Yongin-si (KR); Sang-Jun Kong, Yongin-si (KR); Hyun-Min Son, Yongin-si (KR)

(21) Appl. No.: 13/171,049

(22) Filed: Jun. 28, 2011

(30) Foreign Application Priority Data
Jul. 16, 2010 (KR) 10-2010-0069035

(51) Int. Cl. H01M 8/24; H01M 8/10

(52) U.S. Cl. 429/466; 429/495

(57) ABSTRACT

A solid oxide fuel cell assembly includes a unit cell including an anode, an electrolytic layer, and a cathode that are sequentially stacked, and an adapter at one end of the unit cell, the adapter being coupled to the anode or the cathode of the unit cell and configured to collect current.

### CROSS-REFERENCE TO RELATED APPLICATION

This application claims priority to and the benefit of Korean Patent Application No. 10-2010-0069035, filed on Jul. 16, 2010, in the Korean Intellectual Property Office, the entire content of which is incorporated herein by reference.

### BACKGROUND

1. Field

An aspect of the present invention relates to a solid oxide fuel cell.

2. Description of Related Art

A solid oxide fuel cell is manufactured as a bundle or a stack by connecting a plurality of unit cells. The process of connecting the unit cells is performed using a separate current collector in a form of a wire that contacts outer circumferential surfaces of the unit cells. However, the wiring is performed using precious metals, such as Ag, as the current collector. Therefore, when a large amount of such precious metal is used, cost is highly increased. Further, in a case where the wiring is performed using Ag, or the like, current collection loss frequently occurs due to the line contact between the wire and the outer circumferential surfaces of the unit cells.

### SUMMARY

In one embodiment of the present invention, there is provided a solid oxide fuel cell in which an adapter with a cap structure is at an end of each unit cell, and the adapters with the cap structure are connected to each other, so that it is possible to enable the current collection or electrical connection between the unit cells.

In one embodiment of the present invention, there is provided a solid oxide fuel cell in which the adapters are connected using a separate connector, so that a bundle or a stack can be easily manufactured.

According to an aspect of embodiments of the present invention, there is provided a solid oxide fuel cell including a unit cell including an anode, an electrolytic layer, and a cathode that are sequentially stacked, and an adapter at one end of the unit cell, the adapter being coupled to the anode or the cathode of the unit cell and configured to collect current.

The adapter may include a cover portion for covering the one end of the unit cell, and at least one coupling projection or at least one coupling groove piece, extending from the cover portion.

The at least one coupling projection may include a first extending portion extending from an outer surface of the cover portion, and a second extending portion extending from an end of the first extending portion.

The second extending portion may extend in two directions that are substantially perpendicular to the first extending portion.

The second extending portion may extend in a radial direction from the end of the first extending portion.

The second extending portion may have a substantially circular shape.

The coupling groove piece may include a block body extending from the cover portion, and a fastening groove in the block body.

The fastening groove may include a first groove extending inward from an outer end of the block body, and a second groove extending from one end of the first groove.

The second groove may extend toward two ends of the block body in directions that are substantially perpendicular to the first groove.

The second groove may extend in a radial direction at the one end of the first groove.

The second groove may have a circular shape.

An outer surface of the at least one coupling projection or an inner surface of the fastening groove may be tapered.

The solid oxide fuel cell may further include a stopper projection on an outer surface of the at least one coupling projection or on an inner surface of the fastening groove.

A depth of the fastening groove may be less than a height of the block body.

The adapter may have a substantially cylindrical or polygonal shape.

According to another aspect of embodiments of the present invention, there is provided a solid oxide fuel cell assembly including a plurality of unit cells, each of the unit cells including an anode, an electrolytic layer, and a cathode that are sequentially stacked, and an adapter on an end of one of the unit cells, the adapter being coupled to the anode or the cathode of the one of the unit cells and configured to collect current, the adapter including a cover portion for covering an end of one of the unit cells, and at least one coupling projection or at least one coupling groove piece, extending from the cover portion, the at least one coupling groove piece having a fastening groove, wherein the plurality of unit cells are coupled to one another by at least one of the coupling projection or the fastening groove.

The coupling projection and the fastening groove may be coupled using a forcible insertion method.

The solid oxide fuel cell assembly may further include a stopper projection on an outer surface of the coupling projection or on an inner surface of the fastening groove.

An outer surface of the coupling projection or an inner surface of the fastening groove may be tapered.

The coupling projection or the fastening groove may extend from an outer surface of the cover portion.

The adapter may be coupled to an external connector including a connector fastening groove or a connector coupling projection.

Inner surfaces of the connector fastening groove or outer surfaces of the connector coupling projection may be tapered.

The solid oxide fuel cell assembly may further include a stopper projection on an outer surface of the connector coupling projection or an inner surface of the connector fastening groove.

A depth of the connector fastening groove may be less than a height of the external connector.

As described above, according to embodiments of the present invention, the connection between unit cells can be easily and firmly formed in a solid oxide fuel cell.

Also, since a bundle or a stack is manufactured without using a high-priced precious metal, such as Ag, as a current collection structure or electrical connection structure, economical efficiency can be enhanced.

### BRIEF DESCRIPTION OF THE DRAWINGS

The accompanying drawings, together with the specification, illustrate exemplary embodiments of the present invention, and, together with the description, serve to explain aspects of embodiments of the present invention.

FIG. 1 is a schematic exploded perspective view showing a coupling projection and a coupling groove piece, which constitute the structure of adapters in a fuel cell, according to an embodiment of the present invention.

FIGS. 2(a) to 2(d) are partial sectional views showing cross-sections of the structure of adapters of various shapes in the fuel cell according to embodiments of the present invention.

FIG. 3 is an exploded perspective view showing the structure of an adapter in the fuel cell according to an embodiment of the present invention.

FIGS. 4(a) to 4(e) are partial sectional views showing cross-sections of the structure of adapters of various shapes in the fuel cell and also showing coupling projections and coupling groove pieces in the fuel cell according to embodiments of the present invention.

FIG. 5 is a schematic exploded perspective view showing a coupling structure for connecting a connector used in a fuel cell assembly according to an embodiment of the present invention.

FIGS. 6(a) to 6(d) are schematic exploded perspective views showing connectors used in the fuel cell assembly according to embodiments of the present invention.

FIGS. 7(a) to 7(d) are partial sectional views showing cross-sections of the structure of connectors and adapters used in the fuel cell assembly according to embodiments of the present invention.

### DETAILED DESCRIPTION

In the following detailed description, only certain exemplary embodiments of the present invention have been shown and described, simply by way of illustration. As those skilled in the art would realize, the described embodiments may be modified in various ways, all without departing from the spirit or scope of the present invention. Accordingly, the drawings and description are to be regarded as illustrative in nature and not restrictive. In addition, when an element is referred to as being “on” another element, it can be directly on the another element or indirectly on the another element with one or more intervening elements interposed therebetween. Also, when an element is referred to as being “connected to” or “coupled to” another element, it can be directly connected to the another element or indirectly connected to the another element with one or more intervening elements interposed therebetween. Hereinafter, like reference numerals refer to like elements. In the drawings, the thickness or size of layers are exaggerated for clarity and are not necessarily drawn to scale.

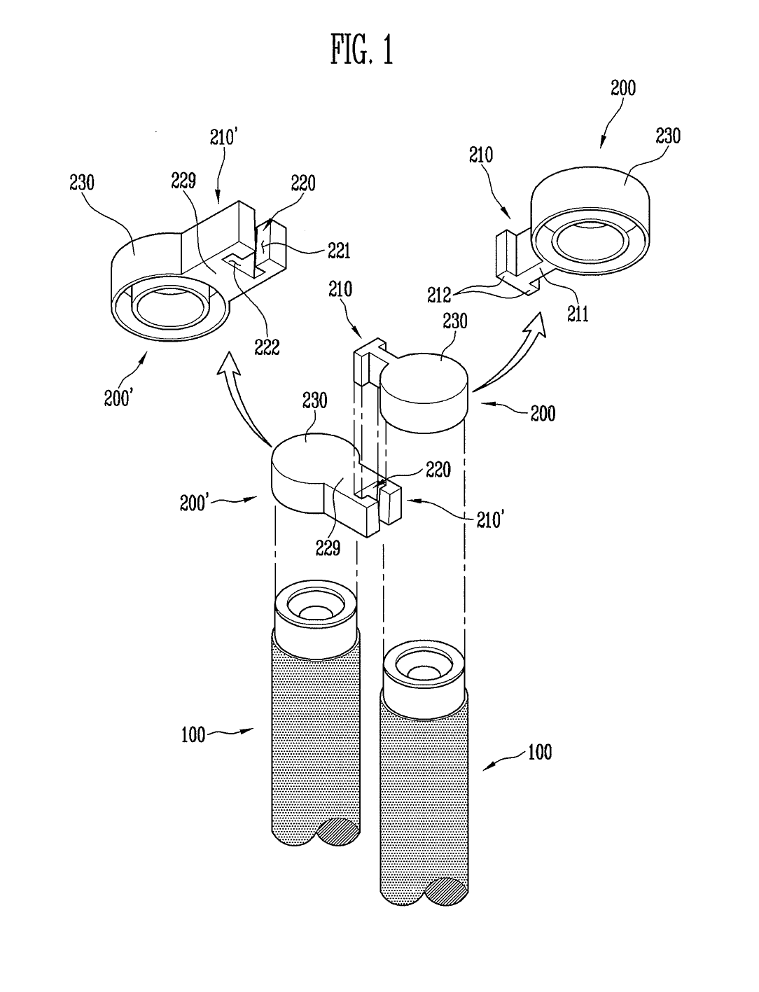

FIG. 1 is a schematic exploded perspective view showing unit cells and the structure of an adapter for connection between the unit cells in a fuel cell according to an embodiment of the present invention.

An adapter used in embodiments of the present invention is a general term for a connection body for connecting two or more electrical appliances or devices. In embodiments of the present invention, the adapter will be commonly used as a connection body for connecting unit cells. It is assumed that the unit cell may include a structure in which a plurality of sub-cells are connected to one another.

In FIG. 1, a unit cell 100 has a multiple-tube structure in which an anode, an electrolytic layer, and a cathode are sequentially stacked. However, the shape of each of such layers and the structure of an additional current collecting body are not essential for a complete understanding of the present invention, and therefore, their detailed descriptions will be omitted. In the present embodiment, current collection is performed by forming an adapter 200 or 200′ with a cap structure at one end of the unit cell 100. It is assumed that the adapter 200 or 200′ is fixed in the form of a cap to the one end of the unit cell 100 and electrically connected to a respective one of the anode or cathode using various methods.

In this embodiment, an adapter 200 or 200′ with a cap structure is provided to an end of a unit cell 100 to form a current collecting body of the unit cell 100. The adapter 200 or 200′ includes a cover portion 230 that covers an end of the unit cell 100. A coupling projection 210 extends from the cover portion 230 of the adapter 200, and a coupling groove piece 210′ extends from the cover portion 230 of the adapter 200′. In the described embodiment, the coupling projection 210 and the coupling groove piece 210′ have respective structures that enable them to be electrically and physically coupled to each other.

That is, in the present embodiment, the current collecting body connected to the cathode or anode is formed into the structure of the adapter 200 or 200′ with a cap shape. The adapter 200 has a structure in which the coupling projection 210 extends from the cover portion 230, and the adapter 200′ has a structure in which the coupling groove piece 210′ extends from the cover portion 230, to couple a plurality of unit cells 100 electrically and physically to each other.

By using a method of inserting a coupling projection 210 of one adapter 200 into a coupling groove piece 210′ of another adapter 200′ so that they are coupled to each other, the fastening of a plurality of unit cells 100 can be firmly and stably performed as compared with a method of wiring a plurality of unit cells through an Ag wire and connecting the plurality of unit cells through the Ag wiring.

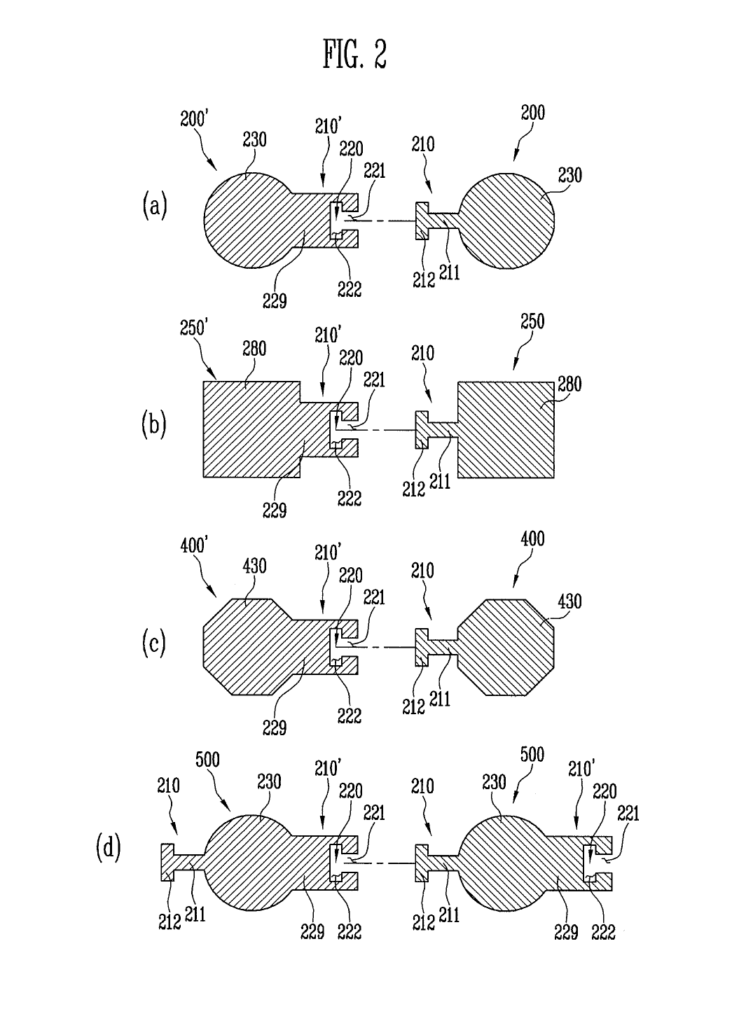

FIGS. 2(a) to 2(d) are partial sectional views showing cross-sections of various shapes of adapters according to embodiments of the present invention, in which cross-sections of circular, quadrilateral, and polygonal adapters are partially shown.

That is, adapters 200, 200′, 250, 250′, 400, 400′ and 500 according to the embodiments may have various shapes (e.g., various cross-sectional shapes) corresponding to the shape of a unit cell 100 and/or the efficiency of a current collection structure. In FIG. 2(a), FIG. 2(b), FIG. 2(c), and FIG. 2(d), circular, quadrilateral, and octagonal shapes are shown according to the embodiments of the present invention. However, the present invention is not limited thereto. For example, elliptical, hexagonal, triangular, or flat tubular shapes, and/or the like may be used in other embodiments of the present invention.

The connection structures of the adapters 200, 200′, 250, 250′, 400, 400′ and 500 according to embodiments of the present invention will be described in detail. First, the connection structure of the adapter 200 with a cylindrical cap structure, shown in FIGS. 1, 2(a), 2(d), and 3, will be described as exemplary embodiments. Referring to FIGS. 1 and 2(a), the adapter 200 is connected to a cathode or anode at one end of a unit cell 100 to enable current collection, and includes a cover portion 230 that covers one end of the unit cell 100. A coupling projection 210 is formed to extend outward from an outer surface (e.g., an outer circumferential surface) of the cover portion 230. The coupling projection 210 includes a first extending portion 211 that is a horizontal piece extended (e.g., immediately extended) from the adapter 200, and a second extending portion 212 that is a vertical piece formed to extend to both sides of an end of the first extending portion 211.

In embodiments of the present invention, the first extending portion 211 may be referred to as a horizontal piece and the second extending portion 212 may be referred to as a vertical piece to distinguish them from each other. It will be apparent that the directional terms may be changed depending on a direction viewed.

The adapter 200′ with the coupling groove piece 210′ corresponding to the first and second extending portions 211, 212 is connected to a cathode or an anode at one end of another unit cell 100 to enable current collection, and includes a cover portion 230 that covers the one end of the unit cell 100. A block body 229 extends outward from an outer surface (e.g., an outer circumferential surface) of the cover portion 230. A fastening groove 220 for allowing the coupling projection 210 to be fastened thereto is formed in the block body 229. The fastening groove 220 includes first and second grooves 221 and 222, respectively, corresponding to the first and second extending portions 211 and 212 of the coupling projection 210. The first groove 221 is formed inward from an outer end of the block body 229, and the second groove 222 extends to both sides (e.g., sides of the block body 229) from one end (e.g., an inner end) of the first groove 221.

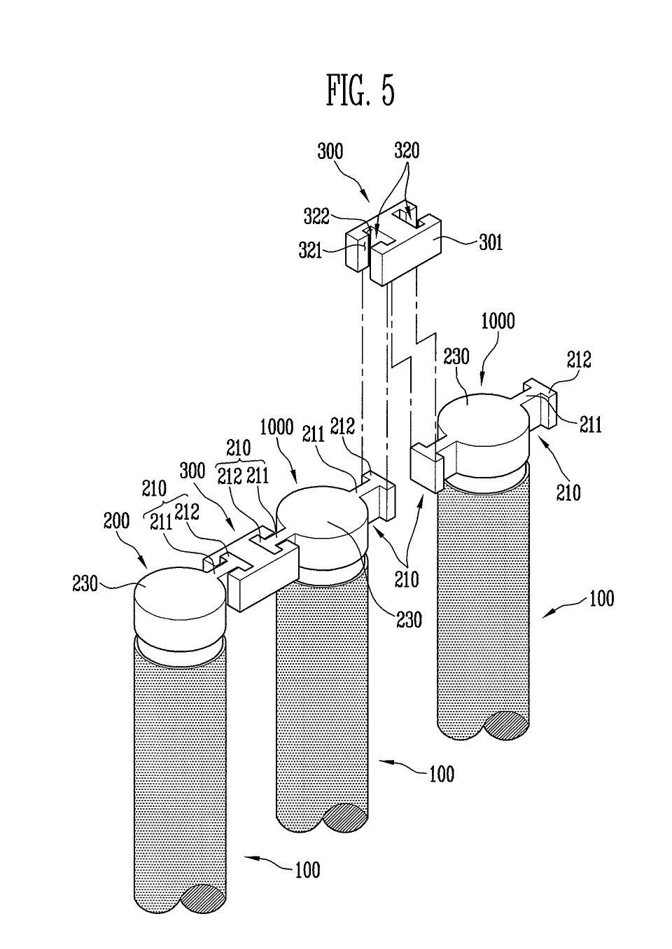

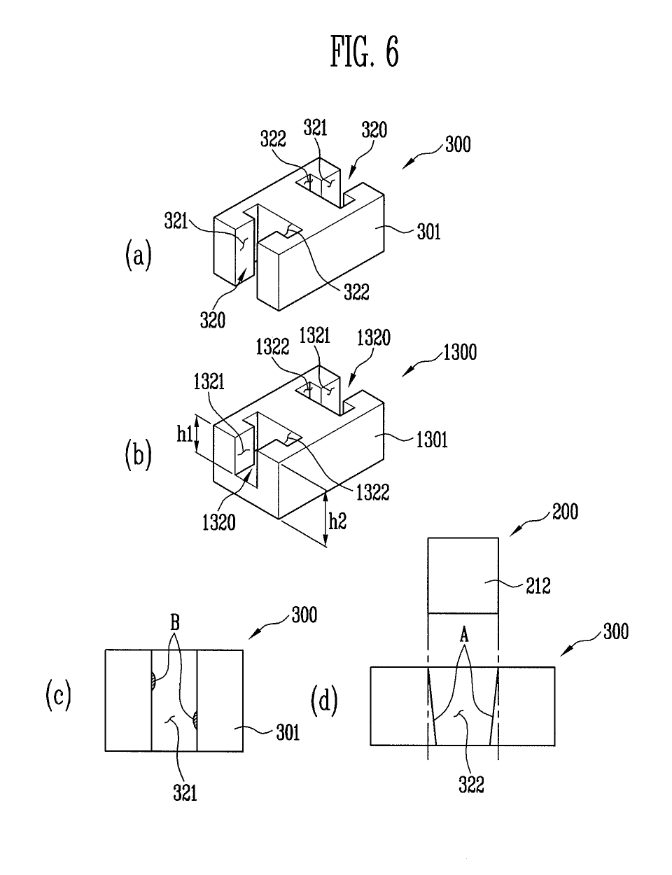

In the embodiment of the present invention shown in FIG. 2(d), an adapter 500 is simultaneously provided with a coupling projection 210 extended from one side thereof and a coupling groove piece 210′ extended from the other side thereof. In this case, an additional connector 300 (see FIGS. 5 and 6), which will be described later, is unnecessary, and continuous connection of adapters 500 is possible.

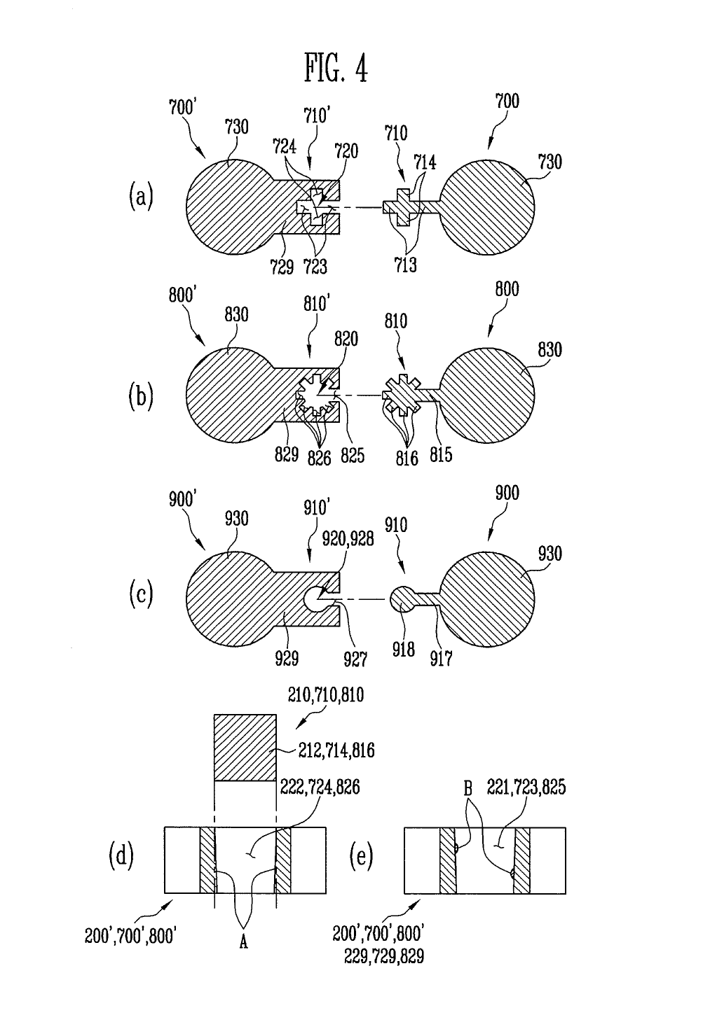

The first and second extending portions 211 and 212 of the coupling projection 210 may be fixedly fastened to the first and second grooves 221 and 222, respectively, of the coupling groove piece 210′ using a forcible insertion method. In this case, a stopper projection (e.g., stopper projection B of FIG. 4(e)) may be formed on one or more outer surfaces (e.g., outer circumferential surfaces) of the first and second extending portions 211 and 212, or may be formed on one or more inner surfaces (e.g., inner circumferential surfaces) of the first and second grooves 221 and 222, so as to reinforce a fastening force between the coupling projection 210 and the coupling groove piece 210′. Alternatively, the one or more inner surfaces (e.g., inner circumferential surfaces) of the first and second grooves 221 and 222 may be formed in a tapered shape so that the fastening force is reinforced by forcibly inserting the first and second extending portions 211 and 212 into the first and second grooves 221 and 222, respectively. This structure will be described in detail in reference to the following embodiment.

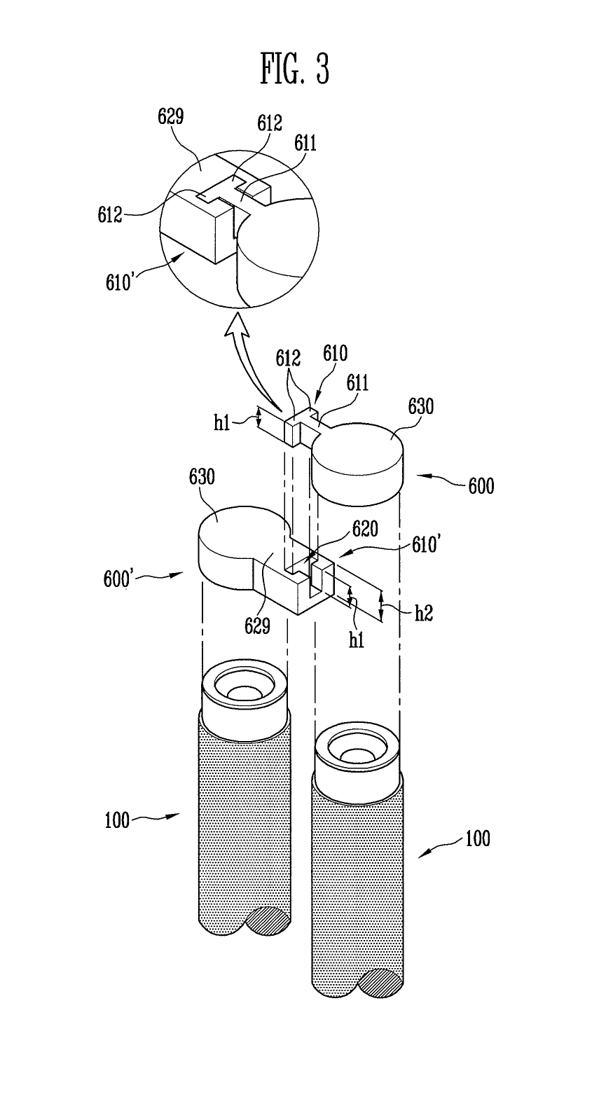

The fastening groove 220 in the coupling groove piece 210′ may be formed by passing through the block body 229 (e.g., through two surfaces of the block body 229), or may be formed by passing only partially through a block body 629 (of FIG. 3) on one region of the block body 629.

In FIG. 3, an adapter 600 includes a cover portion 630 and a coupling projection 610 extending therefrom, and an adapter 600′ includes a cover portion 630 and a coupling groove piece 610′ extending therefrom. The coupling projection 610 has a first extending portion 611 and a second extending portion 612 that are similar to those of the coupling projection 210. The coupling groove piece 610′ has a block body 629 and a fastening groove 620 that are similar to those of the coupling groove piece 210′

A depth h1 of the fastening groove 620 formed in the block body 629 of the adapter 600′ is formed smaller than a height h2 of the block body 629. This is for preventing the possibility of the coupling projection 610 slipping out of the fastening groove 620 through the bottom end of the fastening groove 620 (e.g., if a greater sliding force than expected is provided when the coupling projection 610 is slidingly fastened to the fastening groove 620 from the top to bottom of the adapter 600′).

In the present embodiment, it has been illustratively described that two unit cells 100 are connected to each other. However, if it is desired to connect more than two unit cells 100, two coupling groove pieces 210′ or two coupling projections 210 may be formed at the adapter 200. Alternatively, a coupling projection 210 may be formed to extend at one side of the adapter 200, and a coupling groove piece 210′ may be formed to extend at the other side of the adapter 200 (see FIG. 2(d)). Alternatively, a plurality of coupling projections 210 or coupling groove pieces 210′ (e.g., a plurality of a number greater than the two) may be formed at the adapter 200 to connect unit cells 100 to one another.

The adapters 250 and 250′ of FIG. 2(b) have substantially similar structure as the adapters 200 and 200′, respectively, of FIG. 2(a), except for the cross-sectional shape of a cover portion 280, which is rectangular (e.g., square-shaped). The coupling projection 210 extends from the cover portion 280 of the adapter 250, and the coupling groove piece 210′ extends from the cover portion 280 of the adapter 250′. Similarly, the adapters 400 and 400′ of FIG. 2(c) have substantially similar structure as the adapters 200 and 200′, respectively, of FIG. 2(b), except for the cross-sectional shape of a cover portion 430, which is octagonal. The coupling projection 210 extends from the cover portion 430 of the adapter 400, and the coupling groove piece 210′ extends from the cover portion 430 of the adapter 400′. The adapters 250, 250′ or the adapters 400, 400′ are used with unit cells 100 having respectively similar cross-sectional shapes, as those skilled in the art would appreciate.

FIGS. 4(a) to 4(c) are cross-sectional views of structures of adapters 700, 700′, 800, 800′, 900, and 900′ according to further embodiments of the present invention. FIG. 4(a) shows the structure of the adapters 700 and 700′ that are provided, respectively, with a cross-shaped coupling projection 710 and a coupling groove piece 710′ having a fastening groove 720 corresponding to the cross-shaped coupling projection 710. FIG. 4(b) shows the structure of the adapters 800 and 800′ that are provided, respectively, with a coupling projection 810 that has second extending portions 816 protruded in a radial direction and a coupling groove piece 810′ having a fastening groove 820 corresponding to the coupling projection 810.

In FIG. 4(a), second extending portions 714 of the coupling projection 710 intersect a first extending portion 713 extending from an outer surface (e.g., an outer circumferential surface) of the cover portion 730. That is, the second extending portions 714 are formed to extend from both sides of the first extending portion 713 while intersecting with the first extending portion 713 at one region of the first extending portion 713. Meanwhile, the fastening groove 720 in the coupling groove piece 710′ corresponding to the coupling projection 710 is also formed so that first and second grooves 723 and 724 intersect each other in a block body 729 extended from a cover portion 730 that covers one end of a unit cell 100. The first and second grooves 723 and 724 are formed in the corresponding shape as the first and second extending portions 713 and 714, such that the first and second extending portions 713 and 714 can fit (e.g., engage) the first and second grooves 723 and 724. Thus, for example, the first and second extending portions 713 and 714 of the coupling projection 710 are coupled to the first and second grooves 723 and 724, respectively, of the coupling groove piece 710′ using a forcible insertion method.

The coupling projection 810 of the adapter 800 that includes the second extending portions 816 formed in a radial direction at one end (e.g., a distal end) of the first extending portion 815, and a coupling groove piece 810′ of the adapter 800′ that corresponds to the coupling projection 810 are shown in FIG. 4(b). That is, the coupling projection 810 includes the first extending portion 815 that extends from a cover portion 830 of the adapter 800 and a plurality of second extending portions 816 protruded in a radial direction from the first extending portion 815 (e.g., protruding radially from an end of the first extending portion 815).

The coupling groove piece 810′ has a fastening groove 820 to which the first extending portion 815 and the plurality of second extending portions 816 are fixedly fastened. The coupling groove piece 810′ extends from a surface (e.g., outer circumferential surface) of a cover portion 830 of the adapter 800′, and includes a block body 829 having the fastening groove 820. The fastening groove 820 includes a first groove 825 into which the first extending portion 815 is inserted and a second groove (e.g., a plurality of second grooves) 826 coupled to the plurality of second extending portions 816 protruded in the radial direction. The first and second grooves 825 and 826 are also formed in corresponding shapes as the first and second extending portions 815 and 816, respectively, so as to fit with (or engage) the first and second extending portions 815 and 816. In FIG. 4(a) and FIG. 4(b), the coupling projection 710, 810 and the coupling groove piece 710′, 810′ may be coupled to each other using the forcible inserting method, for example.

FIG. 4(c) illustrates adapters 900 and 900′ that are respectively provided with a coupling projection 910 having a different shape, and a coupling groove piece 910′ corresponding to the coupling projection 910. The coupling projection 910 shown in FIG. 4(c) includes a first extending portion 917 that extends from a cover portion 930 that covers one end of a unit cell 100, and a second extending portion 918, which is a circular projection at an end (e.g., a distal end) of the first extending portion 917. The coupling groove piece 910′ having a fastening groove 920 corresponding to the second extending portion 918 with the circular projection including a first groove 927 in which the first extending portion 917 is inserted in a block body 929, and a circular second groove 928 extended from the first groove 927 to allow the second extending portion 918 to be inserted thereinto. In the present embodiment, the fastening groove 920 includes the first and second grooves 927 and 928.

Other structures for reinforcing the fastening force between the coupling projection 210, 710, 810 and the coupling groove piece 210′, 710′, 810′ are shown in FIG. 4(d) and FIG. 4(e). FIG. 4(d) schematically shows a longitudinal sectional view of the portion at which the second extending portion 212, 714, or 816, which respectively constitutes the coupling projection 210, 710, or 810, is fixedly fastened to the second groove 222, 724 or 826, respectively, of the adapter 200′, 700′ or 800′, into which the second extending portion 212, 714 or 816 is inserted (e.g., in the adapter 200′, 700′ or 800′). FIG. 4(e) schematically shows a longitudinal portion of the first groove 221, 723, or 825 into which the first extending portion 211, 713, or 815 is inserted (e.g., in the fastening groove 220, 720, or 820, respectively, of the adapter 200′, 700′ or 800′).

As can be seen in these figures, both inner surfaces of the second groove 222, 724, or 826, which respectively constitute the fastening groove 220, 720, or 820, are formed as tapered surfaces A, for example, as shown in another embodiment of FIG. 4(d). Here, the tapered surfaces A face each other, and the width between the tapered surfaces A decreases as it goes down (e.g., in a downward direction). In a case where the tapered surfaces A are formed as described above, the fastening force between the second extending portion 212, 714, or 816 and the second groove 222, 724, or 826 can be further reinforced due to the tapered surfaces A when the second extending portion 212, 714, or 816, which respectively constitutes the coupling projection 210, 710, or 810, is inserted into the second groove 222, 724, or 826.

That is, as shown in FIG. 4(d), the inner surfaces of the second groove 222, 724, or 826, respectively, of the fastening groove 220, 720, or 820 are formed as the tapered surfaces A in which the width between the tapered surfaces A decreases as it goes down (e.g., the width between the tapered surfaces A near the bottom is less than the width between the tapered surfaces A near the top). Separate stopper projections B may be respectively formed on the tapered surfaces A or inner surfaces of the first groove 221, 723, or 825 of another fastening groove shown in FIG. 4(e) according to another embodiment. In this case, the fastening force between the first extending portion 211, 713, 815 and the first groove 221, 723, 825 can be further strengthened (e.g., reinforced).

In FIG. 4(c), the coupling projection 910 and the coupling groove piece 910′ are formed in a circular shape. However, the tapered surfaces A and/or stopper projections B or similar structures may also be formed.

FIG. 5 shows an assembly of unit cells 100 formed by connecting the structures of adapters 200 and 1000 to one another according to an embodiment of the present invention.

Since structures of the adapters 200 and 1000 of the present embodiment are substantially the same as those of an aforementioned embodiment, redundant descriptions will be omitted. However, each of the structures of the adapters 1000 of the present embodiment includes a cover portion 230 that covers one end of a unit cell 100, and coupling projections 210 respectively formed to extend in both directions from an outer surface (e.g., outer circumferential surface) of the cover portion 230. As shown in FIG. 5, the adapters 200 and 1000 provided with one or two coupling projections 210 are connected to one another through separate connectors (e.g., external connectors) 300. That is, the adapter 200 or 1000 is provided with various shapes of coupling projections 210 formed to protrude from one or both sides from the cover portion 230 of the adapter 200 or 1000. In the present embodiment, the coupling projection 210 includes first and second extending portions 211 and 212. A connector 300 is provided to have connector fastening grooves 320 corresponding to the first and second extending portions 211 and 212 at both sides thereof. The connector 300 is provided with connector fastening grooves 320, each connector fastening groove 320 having first and second grooves 321 and 322. Here, the first and second extending portions 211 and 212 are fastened to the connector fastening grooves 320 (e.g., first and second grooves 321 and 322, respectively).

That is, as can be seen in FIGS. 5 and 6(a), if two unit cells 100 are connected to each other, a coupling projection 210 is formed at a side of an adapter 200 or 1000 that is fastened to an upper end of each of the unit cells 100, and a connector fastening groove 320 is formed at a side of a connector 300 corresponding to the adapter 200 or 1000. Although not shown in these figures, the coupling projection (e.g., a connector coupling projection) may instead be protruded from the connector 300, and the fastening groove may instead be formed in the adapter 200 or 1000. If more than two unit cells 100 are connected to one another, one or more coupling projections 210 or fastening grooves (not shown) may be formed at each adapter 200 or 1000, and/or one or more connector fastening grooves 320 or connector coupling projections (not shown) may be formed at each connector 300 corresponding to the adapter 200 or 1000.

Other shapes in different embodiments of the connector 300 are shown in FIGS. 6(b) to 6(d). While the connector fastening groove 320 in FIG. 6(a) passes through the body of the connector 300, a connector fastening groove 1320 in FIG. 6(b) is formed to not pass entirely through the body of a connector 1300. This is for preventing the possibility that a coupling projection 210 or 610 might slip out of the connector fastening groove 1320 through the bottom end of the connector fastening groove 1320 of the connector 1300, which is accomplished because the depth h1 of the connector fastening groove 1320 is formed smaller than the height h2 of the body of the connector 1300. The connector 1300 has the connector fastening grooves 1320 formed at both ends thereof. Each connector fastening groove 1320 has first and second grooves 1321 and 1322.

In other embodiments of the present invention shown in FIG. 6(c) and FIG. 6(d), both inner surfaces of each of the first and second grooves 321 and 322, which constitute the connector fastening groove 320 of the connector 300, are formed as tapered surfaces A, or separate stopper projections B are formed on both inner surfaces of the first groove 321 and/or the second groove 322. Here, the tapered surfaces A (or the inner surfaces) face each other, and the width between the tapered surfaces A decreases as it goes down. Thus the fastening force between the adapter (e.g., adapter 200, 250, 400, 500, or 1000) and the connector 300 can be further reinforced by the tapered surfaces A and/or the stopper projections B.

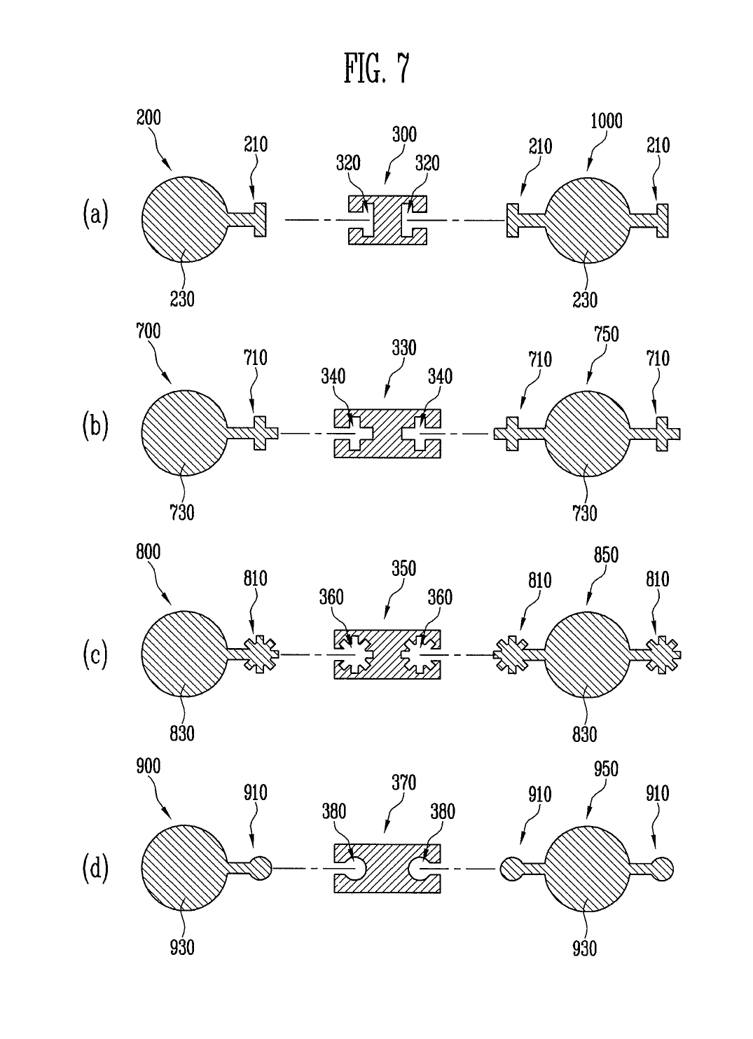

FIGS. 7(a) to 7(d) show structures of embodiments of the present invention in which adapters 200, 1000, 700, 750, 800, 850, 900, and 950 provided with coupling projections 210, 710, 810, and 910 of various shapes are connected to connectors 300, 330, 350, and 370 provided with connector fastening grooves 320, 340, 360, and 380 of various shapes corresponding to the coupling projections 210, 710, 810, and 910, respectively.

Since the structures of the coupling projections 210, 710, 810, and 910 and the connector fastening grooves 320, 340, 360, and 380, respectively, in FIG. 7(a), FIG. 7(b), FIG. 7(c) and FIG. 7(d) are substantially the same as those of aforementioned embodiments, their redundant descriptions will be omitted. However, in the present embodiment, a plurality of coupling projections 210, 710, 810, and 910 opposite each other are formed at the adapters 1000, 750, 850, and 950, respectively, as shown in FIGS. 7(a) to 7(d). In a case where a plurality of coupling projections 210, 710, 810, or 910 opposite each other are respectively formed at the adapters 1000, 750, 850, or 950, and the adapters 1000, 750, 850, or 950 are respectively connected to the connectors 300, 330, 350, or 370 respectively provided with the connector fastening grooves 320, 340, 360, or 380, corresponding to the coupling projections 210, 710, 810, or 910, respectively, a stack can be easily manufactured by connecting a large number of unit cells 100 to one another.

If two unit cells 100 are connected to each other, a coupling projection 210, 610, 710, or 810 is formed at a side of an adapter 200, 250, 400, 500, 600, 700, 750, 800, 850, 900, 950, or 1000 that is fastened to an upper end of each of the unit cells 100, and a connector fastening groove 320, 340, 360, or 380 is formed at a side of a connector 300, 330, 350, or 370 corresponding to the adapter 200, 250, 400, 500, 600, 700, 750, 800, 850, 900, 950, or 1000. Although not shown in this figure, a connector coupling projection may be protruded from the connector 300, 330, 350, or 370, and the connector fastening groove 320, 340, 360, or 380 may be formed in the adapter 200, 250, 400, 500, 600, 700, 750, 800, 850, 900, 950, or 1000. If more than two unit cells 100 are connected to one another, one or more coupling projections 210, 610, 710, or 810 or fastening grooves (not shown) may be formed at each adapter 200, 250, 400, 500, 600, 700, 750, 800, 850, 900, 950, or 1000, and/or one or more connector fastening grooves 320, 340, 360, or 380 or connector coupling projections (not shown) may be formed at each connector 300, 330, 350, or 370 corresponding to the adapter 200, 250, 400, 500, 600, 700, 750, 800, 850, 900, 950, or 1000.

In embodiments of the present invention, the structure of a cap-shaped adapter 200, 500, 600, 700, 750, 800, 850, 900, 950, or 1000 as described above applied to a unit cell 100, and a plurality of such unit cells 100 are connected to one another, thereby manufacturing a bundle portion or stack. In other embodiments, the unit cells 100 may have different shapes (e.g., a non-circular cross-section), and the adapters 250 or 400, for example, may be used to connect the unit cells 100 having rectangular (e.g., square shaped) or octagonal cross-sections, respectively.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

That is, it has been described in the embodiments of the present invention that the connection structure of unit cells 100 is applied to anode-supported solid oxide fuel cells. However, it will be apparent that the connection structure of unit cells 100 may be identically applied to cathode-supported solid oxide fuel cells or other various tubular or flat tubular fuel cells.

What is claimed is:

1. A solid oxide fuel cell comprising:
a unit cell comprising an anode, an electrolytic layer, and a cathode that are sequentially stacked; and
an adapter at one end of the unit cell, the adapter being coupled to the anode or the cathode of the unit cell and configured to collect current.

2. The solid oxide fuel cell according to claim 1, wherein the adapter comprises:
a cover portion for covering the one end of the unit cell; and
at least one coupling projection or at least one coupling groove piece, extending from the cover portion.

3. The solid oxide fuel cell according to claim 2, wherein the at least one coupling projection comprises:
a first extending portion extending from an outer surface of the cover portion; and
a second extending portion extending from an end of the first extending portion.

4. The solid oxide fuel cell according to claim 3, wherein the second extending portion extends in two directions that are substantially perpendicular to the first extending portion.

5. The solid oxide fuel cell according to claim 3, wherein the second extending portion extends in a radial direction from the end of the first extending portion.

6. The solid oxide fuel cell according to claim 3, wherein the second extending portion has a substantially circular shape.

7. The solid oxide fuel cell according to claim 2, wherein the coupling groove piece comprises:
a block body extending from the cover portion; and
a fastening groove in the block body.

8. The solid oxide fuel cell according to claim 7, wherein the fastening groove comprises:
a first groove extending inward from an outer end of the block body; and
a second groove extending from one end of the first groove.

9. The solid oxide fuel cell according to claim 8, wherein the second groove extends toward two ends of the block body in directions that are substantially perpendicular to the first groove.

10. The solid oxide fuel cell according to claim 8, wherein the second groove extends in a radial direction at the one end of the first groove.

11. The solid oxide fuel cell according to claim 8, wherein the second groove has a circular shape.

12. The solid oxide fuel cell according to claim 2, wherein an outer surface of the at least one coupling projection or an inner surface of the fastening groove is tapered.

13. The solid oxide fuel cell according to claim 2, further comprising a stopper projection on an outer surface of the at least one coupling projection or on an inner surface of the fastening groove.

14. The solid oxide fuel cell according to claim 7, wherein a depth of the fastening groove is less than a height of the block body.

15. The solid oxide fuel cell according to claim 1, wherein the adapter has a substantially cylindrical or polygonal shape.

16. A solid oxide fuel cell assembly comprising:
a plurality of unit cells, each of the unit cells comprising an anode, an electrolytic layer, and a cathode that are sequentially stacked; and
an adapter on an end of one of the unit cells, the adapter being coupled to the anode or the cathode of the one of the unit cells and configured to collect current, the adapter comprising:
a cover portion for covering an end of one of the unit cells; and
at least one coupling projection or at least one coupling groove piece, extending from the cover portion, the at least one coupling groove piece having a fastening groove,
wherein the plurality of unit cells are coupled to one another by at least one of the coupling projection or the fastening groove.

17. The solid oxide fuel cell assembly according to claim 16, wherein the coupling projection and the fastening groove are coupled using a forcible insertion method.

18. The solid oxide fuel cell assembly according to claim 16, further comprising a stopper projection on an outer surface of the coupling projection or on an inner surface of the fastening groove.

19. The solid oxide fuel cell assembly according to claim 16, wherein an outer surface of the coupling projection or an inner surface of the fastening groove is tapered.

20. The solid oxide fuel cell assembly according to claim 16, wherein the coupling projection or the fastening groove extends from an outer surface of the cover portion.

21. The solid oxide fuel cell assembly according to claim 16, wherein the adapter is coupled to an external connector comprising a connector fastening groove or a connector coupling projection.

22. The solid oxide fuel cell assembly according to claim 21, wherein inner surfaces of the connector fastening groove or outer surfaces of the connector coupling projection are tapered.

23. The solid oxide fuel cell assembly according to claim 21, further comprising a stopper projection on an outer surface of the connector coupling projection or an inner surface of the connector fastening groove.

24. The solid oxide fuel cell assembly according to claim 21, wherein a depth of the connector fastening groove is less than a height of the external connector.
